(19) United States
(12) Patent Application Publication
(10) Pub. No.: US 2007/0025402 A1
(43) Pub. Date: Feb. 1, 2007

(54) Method and apparatus for controlling the temperature of a laser module in a printing plate exposer

(75) Inventors: Jorg-Achim Fischer, Laboe (DE); Michael Schople, Raisdorf (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/495,137

(22) Filed: Jul. 28, 2006

(30) Foreign Application Priority Data
Aug. 1, 2005 (DE) 10 2005 036 099.8

(51) Int. Cl. H01S 3/04

(52) U.S. Cl. 372/36; 372/34

(57) ABSTRACT

An apparatus and a method control the temperature of a laser module having laser diodes in an external drum printing plate exposer. In the external drum printing plate exposer, there is not sufficient space to permit cooling of the laser modules by Peltier elements, because of the construction. Cooling of the laser modules with Peltier elements is to be made possible, since the latter are able to control the temperature of the laser modules without vibration. The object is achieved by heat from the laser module being led to a Peltier element via a heat conduit.

### BACKGROUND OF THE INVENTION

### Field of the Invention

The invention relates to a method and an apparatus for controlling a temperature of a laser module having at least one laser diode driven in a modulated manner for imaging a printing forming in an exposer, and a Peltier element.

In reproduction technology, printing originals for printed pages are produced. The printing originals contain all the elements to be printed such as texts, graphics and images. For color printing, a separate printing original is produced for each printing ink. For four-color printing, these are the printing inks cyan, magenta, yellow and black (CMYK). However, any desired additional or other printing inks may be involved.

The printing originals separated in accordance with printing inks are also referred to as color separations. From them, electronic printing data which, for example, is present in the form of screened bitmaps is then generated, on the basis of which the printing forms, e.g. printing plates, are then imaged. In this way one printing plate is imaged for each color separation. The printing plates are clamped into presses and then transfer the respectively underlying printing ink to the paper.

By using the printing data, different halftone dots on the printing plate are described. The screen size describes the spacing of individual halftone dots, while the screen angle represents a measure of the different angles assumed by the screens of the different color separations in relation to one another. Here, a halftone dot is formed by a plurality of pixels. The pixels are the smallest elements which can be imaged on the printing plate by an exposer. Depending on the tonal value of the corresponding point on the printing original, more or fewer pixels of a halftone dot are imaged. The halftone dot then appears lighter or darker. The imaging of the printing plates is carried out pixel by pixel by a laser beam which is emitted by laser diodes. The imaging itself is carried out in an exposer. This can be an external drum exposer, internal drum exposer or a flatbed exposer.

An appropriate plate exposer for imaging the printing plates contains an exposure head, such as a laser module, which contains different laser diodes. Each individual laser diode of the laser module emits a laser beam in the direction of a printing plate as a function of the printing data. By use of appropriate optical elements, the laser beam is then focused onto the surface of the printing plate.

For the purpose of imaging a printing plate in an external drum exposer, the printing plate is clamped on the exposer drum of the exposer. One or more laser modules are located on one or more exposure head carriers which are moved axially, parallel to the drum, by a feed spindle. For this purpose, the feed spindle is driven by a stepping motor. While the drum rotates, the corresponding laser module is moved along the printing plate and exposes the surface of the printing plate with one or more image lines as a function of the printing data. The imaging is carried out in the form of a helix in this case. The laser module for this exposure can contain one laser module or, generally, a plurality of laser diodes, for example 64. For the purpose of imaging, the laser module additionally has optical elements for focusing the laser beams onto the printing plate surface.

The laser diodes of the laser modules are generally semiconductor components; these are excited to emit laser beams by electric energy. During the conversion of electric energy into laser radiation, heat is generated, depending on the respective efficiency. Given a conventional efficiency of 30%, 70% of the electric energy consumed is therefore converted into heat. As a result of the power loss, first the laser module as a whole and second the individual laser diodes themselves are heated. As a result of the heating of the laser module as a whole, it is possible for displacement of the individual laser diodes in relation to one another to occur. As a result, the image generated on the printing plate can suffer. The exposed image lines must have an exactly defined spacing from one another for a high-quality printed image. If the spacing of individual image lines from one another deviates by a few μm, for example, this can quite possibly be detected as a loss of quality.

Furthermore, the lifetime of the laser diodes is reduced sharply by corresponding heating.

In order to produce the most uniform printed image possible and in order to increase the lifetime of the laser diodes, provision is made for the laser modules to be cooled. This can be done, for example, by a Peltier element. An appropriate arrangement of such a cooling device is proposed in published European patent application EP 1 398 655 A1, corresponding to U.S. patent disclosure No. 2004/0075733 A1.

Such Peltier elements need a heat sink with a relatively large surface. Via this surface, the heat is discharged to the surrounding air by convection. The more heat that has to be discharged, that is to say the more heat that has to be transported away from the laser modules, the greater is the space required for the Peltier element, necessitated by the configuration.

In the case of an external drum exposer having laser modules which are moved axially along the surface of the printing plates, the space in the region of the laser modules is generally not sufficient to provide Peltier elements here which cool the laser modules appropriately.

### SUMMARY OF THE INVENTION

It is accordingly an object of the invention to provide an apparatus for controlling the temperature of a laser module in a printing plate exposer which overcome the above-mentioned disadvantages of the prior art methods and devices of this general type, which uses a Peltier element for controlling the temperature of laser modules of an external drum exposer.

According to the invention, provision is made for this purpose for the laser module to be cooled by heat from the laser module being led to the Peltier element via a heat conduit. For this purpose, the Peltier element is provided in a region of the exposer suitable for its provision, separated physically from the laser module, and is coupled thermally to the laser module via an appropriate heat transport device for thermal conduction, in such a way that the laser module can be cooled and/or heated.

In this way, it is no longer necessary to connect the Peltier element directly to the laser module. The heat can initially be transported away from the laser module via an appropriate heat transport device. The Peltier element can then be made available at a certain distance at a place which provides sufficient room. This can be, for example, a region in the vicinity of the external cladding of the printing plate exposer. The heat can then be transported away from the laser module and discharged to the surroundings via a heat sink belonging to the Peltier element.

Provision is advantageously made for it to be possible both to cool and to heat the laser module, by heat being led from and/or to the laser module via a heat conduit to and/or from the Peltier element.

By this advantageous further development, it is possible to keep the laser modules, in particular the individual laser diodes, at a constant temperature. The geometric deformation of the laser module also takes place during cooling of the laser module. It is therefore not only necessary to cool the laser module if required but also to heat it if need be in order to ensure uniform imaging of the printing plate.

In order to be able to cool or heat the laser module as beneficially as possible, provision is additionally made for a bipolar power unit that can be driven digitally in a clocked manner by a digital drive device and having analog output signals to be used for the analog drive of the Peltier element.

The digital drive device can be, for example, a CPU which, depending on the external temperature or the temperature of the laser diodes, drives the power unit of the Peltier element accordingly. Particularly beneficially, the power unit can be driven digitally in a clocked manner for this purpose. This is a power unit which is driven digitally in accordance with the principle of pulse width modulation and ultimately outputs analog output signals. The Peltier element itself is then driven by these analog signals, which prolongs the lifetime of the Peltier element and results in that its efficiency is higher than if it itself were driven in a clocked manner in any way. The fact that a bipolar power unit is provided results in that it is additionally possible to use the Peltier element both for cooling and for heating.

In order to assist the Peltier element as well as possible in terms of its heat transport, provision is additionally made for a heat sink of the Peltier element to be cooled actively by a fan for the heat exchange with the surroundings.

In a particularly beneficial inventive development, provision is made for the Peltier element to function as an actuating element in a control loop, specifically for the Peltier element to be driven in a regulated manner as a function of temperature changes of the laser module. For this purpose, provision is in particular made for the Peltier element to be driven actively as a function of the modulation of the individual laser diodes of the laser module. The driving of the digital drive device is regulated by a feedforward control unit.

Since the power loss of the laser diodes arises as a function of their modulation as a function of the printing data, by taking appropriate account of the modulation, the Peltier element can already be driven in such a way that it is able to react to the heat fluctuations of the laser diodes that occur. For this purpose, the feedforward control unit is in particular connected directly to the modulation device for modulating the laser diode signals.

In order to ensure the most linear drive curve of the Peltier element, an analog-digital converter is advantageously provided for feeding the analog output signals from the power unit back to the digital drive device.

In order to permit the most uniform heat transport, provision is made for the heat transport device to be a cooling liquid circuit. The cooling liquid used can be water, for example. Advantageously, the cooling liquid itself is to be cooled only by the Peltier element. The use of a compressor is not necessary. In this way, in particular noise can be avoided and vibrations resulting from a possible compressor do not occur either.

Provision is particularly advantageously made for a low-pressure pump to be provided for circulating the liquid of the cooling liquid circuit. The low-pressure pump can particularly advantageously be a pump with a magnetically mounted rotor or impeller, the intention being for the rotor or the impeller advantageously to be spherically shaped. In this way, low wear of the pump is made possible. As a result of the magnetic mounting, blockages of the pump also occur more rarely, since the rotor/the impeller automatically gives way to smaller contaminants.

The Peltier element itself has an optimal working point for cooling or for heating the cooling liquid. If cooling liquid or the laser module or the laser diodes is or are to be heated or cooled further beyond this working point, the efficiency of the Peltier element decreases. In order to improve the efficiency of the Peltier element and in order also to be able to carry away or supply more heat, provision is particularly beneficially made for at least two Peltier elements for applying or discharging heat to or from the cooling liquid circuit to be operated in parallel or in series. For this purpose, at least two Peltier elements are accordingly provided.

In a particularly beneficial embodiment, at least three Peltier elements connected in parallel and in series are provided to apply and/or discharge heat to and/or from the cooling liquid circuit.

In general terms, by using a plurality of Peltier elements, a cooling/heating output can be achieved which would otherwise be possible only by a compressor-regulated cooling liquid circuit and the disadvantages associated therewith.

Other features which are considered as characteristic for the invention are set forth in the appended claims.

Although the invention is illustrated and described herein as embodied in an apparatus for controlling the temperature of a laser module in a printing plate exposer, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, illustration showing a temperature control apparatus for a laser module of an external drum exposer according to the invention;

FIG. 2 is a block diagram of a particular embodiment of the drive of a Peltier element according to detail A from FIG. 1;

FIG. 3 is a block diagram of a structure of a power unit of the Peltier element;

FIG. 4 is a block diagram of a specific embodiment of a temperature control apparatus; and

FIG. 5 is a graph showing a typical course of the efficiency of a Peltier element as a function of a drive current.

### DESCRIPTION OF THE PREFERRED EMBODIMENTS

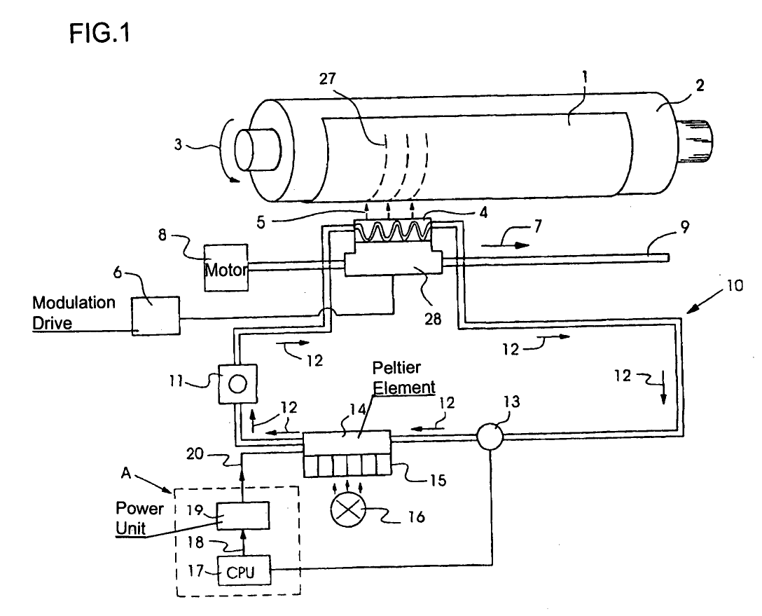

Referring now to the figures of the drawing in detail and first, particularly, to FIG. 1 thereof, there is shown a temperature control apparatus according to the invention for a laser module of an external drum plate exposer. A printing plate 1 is clamped onto a drum 2 of an external drum exposer, not further illustrated here. During the exposure of the printing plate 1, the drum 2 is set rotating in accordance with a rotational arrow 3. At the same time, laser diodes of a laser module 4 emit laser beams 5 as a function of printing data. The laser beams 5 are focused onto the surface of the printing plate 1 by non-illustrated optical elements and, in the process, write image lines 27 on the surface of the printing plate 1.

For the purpose of imaging the printing plate 1, a single laser module 4 is shown; it is also possible for a plurality of laser modules 4 to be used simultaneously in order to expose the printing plate 1 in parallel beside one another. Each laser module 4 contains a large number of laser diodes, for example 64 laser diodes can be provided for one laser module 4. The laser module 4 is located on an exposure head carrier 28. The exposure head carrier 28 is moved in the direction of a feed direction 7 during the exposure of the printing plate 1 by a stepping motor 8 by a feed spindle 9 parallel to an axis of the drum 2. The feed speed of the exposure head carrier 28 is regulated via the stepping motor 8 in such a way that the printing plate 1 is imaged as provided. The individual image lines 27 are in this case exposed helically on the printing plate 1.

The laser diodes of the laser modules 4 are driven by a modulation drive 6 as a function of their relative position in relation to the surface of the printing plate 1 and as a function of printing data. The laser beams 5 are modulated accordingly. Depending on the modulation frequency, the laser diodes heat up in the process. Accordingly, the entire laser module 4 heats up. As a result of the heating, the relative positions of the laser diodes to one another changes and the lifetime of the laser diodes decreases. The laser module 4 and therefore also the laser diodes contained are cooled by a cooling liquid circuit 10. In the cooling liquid circuit 10 there can be, for example, pure water or a mixture of pure water and glycol. The cooling liquid is circulated in the cooling liquid circuit 10 along arrows 12 by a low-pressure pump 11. The cooling liquid circuit 10 is configured in such a way that it meanders in the region of the laser module 4. In this way, it picks up the heat loss output from the laser diodes of the laser module 4 and transports the heat away from the laser module 4. The cooling liquid in the cooling liquid circuit 10 is heated accordingly in the process. The heating of the cooling liquid can be detected by a temperature sensor 13 in the cooling liquid circuit 10. In order to carry the heat away from the cooling liquid circuit 10, a Peltier element 14 is provided. The cooling liquid itself is transported along a cooling side of the Peltier element 14. The Peltier element 14 has a heat sink 15 which can be cooled by a fan 16. In this way, the heat from the cooling side of the Peltier element 14 is discharged to the heat sink 15 and then by convection to the surrounding air.

The Peltier element 14 is able to transport heat away from the cooling liquid as a function of a current that is applied or of voltage that is applied. In order to drive the Peltier element, a drive device is provided in the form of a CPU 17. In this case, the Peltier element 14 is driven as a function of the temperature of the cooling liquid, which is determined by the temperature sensor 13. The temperature is transmitted to the CPU 17. The CPU 17 itself then drives the power unit 19 of the Peltier element 14. This is done by a drive signal 18. On the basis of the drive signals 18, a power unit 19 generates output signals 20 whose values determine the cooling output of the Peltier element 14. In this way, the cooling liquid is cooled down by the Peltier element 14 to such an extent that the latter has a temperature suitable for cooling the laser module 4. A low-pressure pump 11 is set such that the flow rate of the cooling liquid is first sufficient to cool down the laser module 4 appropriately to a constant temperature and that the cooling liquid itself can transfer the heat completely to the Peltier element 14. Provision can also be made in particular for the low-pressure pump 11 to be connected to the CPU 17 so as to be controllable. Further monitoring instruments can be, for example, temperature sensors in the region of the laser module 4 as well. These are not illustrated here.

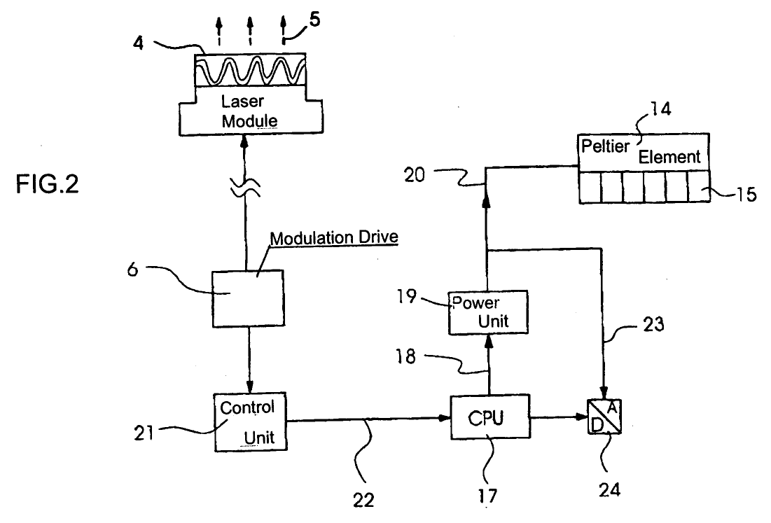

A particular embodiment of the drive of the Peltier element 14 is illustrated in FIG. 2. This involves in particular the elements which are illustrated in the detail A from FIG. 1.

Identical designations describe identical elements to those in FIG. 1. As already described, the laser module 4 is driven by the modulation drive 6 such that the individual laser diodes are modulated and expose image lines 27 as a function of printing data present. The modulation of the laser diodes 4 is then transferred by the modulation drive 6 to a feedforward control unit 21, which passes on a corresponding control signal 22 to the CPU 17. The control signal 22 reflects all of the modulation signals of the laser diodes of the laser module 4. The cooling liquid of the cooling liquid circuit 10 is heated on the basis of these modulation signals. The drive signals from the CPU 17, which can be transferred to the power unit 19, can then already take this power transferred to the cooling liquid into account in advance. Here, the drive signals 18 are to be modulated and thus represent a digital signal form for driving the power unit 19. The power unit 19 is a bipolar, clocked, power unit and is switched as a function of the pulse width of the drive signals 18. Analog output signals 20 are then generated. In this case, these can involve a current or else a voltage, for example, which is applied to the Peltier element 14. The power unit 19 generates the output signals 20 as a function of the drive signals 18. In this case, this can be a nonlinear actuating element, which results in that the power unit 19, at least in the event of a relatively high mark-space ratio of the pulse width modulation of the drive signals 18, no longer generates a current as output signal 20 linearly as a function of the pulse width. In order to compensate for this effect, feedback 23 is provided, which feeds back the analog output signal 20 to the CPU 17, so that linearization can be carried out here. The analog feedback signal is initially digitized by an analog-digital converter 24 to be transferred to the CPU 17. In this way, linear output signals 20 can be generated by the power unit 19. In particular, provision is made for the output signals 20 to be a continuously adjustable current. The level of the current and the direction then indicates whether the Peltier element 14 cools or heats more or less. The fact that a current with a different sign can be generated by the power unit 19 results in that the Peltier element 14 can ensure a constant temperature of the cooling liquid.

Since the relative spacings of the laser diodes of the laser module 4 also change when the cooling liquid is cooled below a predefined value, excessively high cooling of the cooling liquid or the laser module 4 itself also causes a worsening of the resultant printing image on the printing plates 1. This can advantageously be avoided by controlling the temperature of the cooling liquid by the Peltier element 14. For this purpose, the Peltier element 14 can be used as an active control element. Depending on the measured temperature of the cooling liquid by the temperature sensor 13, the cooling liquid can be heated or cooled. This is controlled appropriately via CPU 17. The power unit 19 can advantageously also be driven via the CPU 17 in such a way that the modulation signals of the laser diodes are already taken into account in order to ensure a constant temperature of the laser module 4 of 25° C., for example, in good time. In conjunction with appropriate control of the low-pressure pump 11 by the CPU, the control circuit can be improved further. The power unit 19 outputs an analog current value as output signal. This can assume continuously positive and negative values.

By the linear analog driving of the Peltier element 14, a particularly beneficial efficiency of the Peltier element 14 is achieved. This is because if the Peltier element 14 is driven by a high-frequency voltage or a high-frequency current with a frequency above 10 kHz, the result is a low efficiency because of capacitive behavior. At very low frequencies below 1 kHz, the result is lifetime problems of the Peltier element. Only in the event of analog linear driving, that is to say by a direct current, is an optimized efficiency achieved here. This is ensured by the bipolar power unit 19.

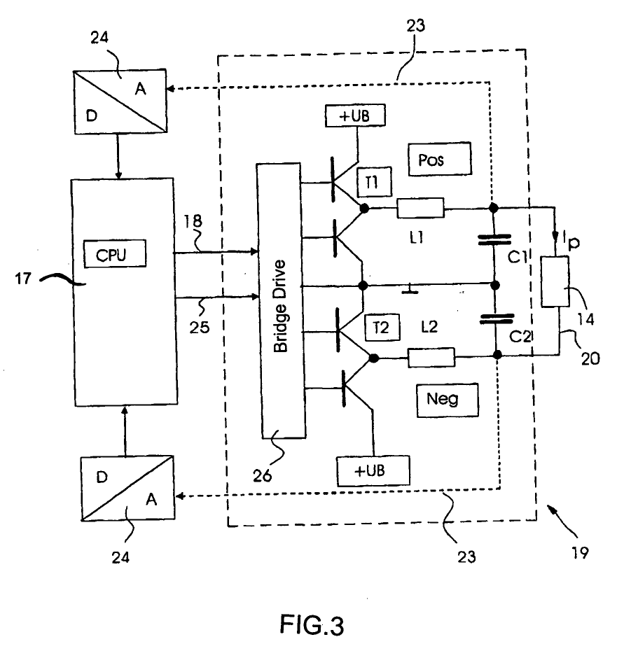

FIG. 3 shows a practical embodiment of the power unit 19.

A positive or negative current I_{P} is to be set on the Peltier element 14. For this purpose, the CPU 17 generates a pulse width modulated drive signal 18. This reproduces the magnitude of the desired current I_{P}. The current I_{P} here is the output signal 20 from the power unit 19. The pulse width modulated signal 18 is intended to have a period in the kilohertz range and a mark-space ratio of about 5 to 100%. Furthermore, the power unit 19 can be driven over a very wide current range. In addition to the information about the magnitude of the current I_{P}, provision is made for the CPU 17 to transmit a direction signal 25 to the power unit 19. The direction signal indicates whether the current I_{P} is to be positive or negative. Instead of a current I_{P}, provision can also be made for the output signal 20 to be a voltage U_{P}. The control is then carried out in a corresponding manner.

To generate the output signal 20, a bridge driver 26 is provided. The latter drives the output transistors T1 and T2 as a function of the drive signals 18 and the direction signals 25. Depending on the direction signal 25 applied, either the output transistors T1 are driven for a positive output signal 20 or the output transistors T2 are driven for a negative output signal 20, that is to say for a negative current I_{P}. Depending on the transistors T1 or T2 driven, a direct current is generated by the coils and capacitors L1, C1 and L2, C2. This direct current then controls the Peltier element 14 appropriately.

The direct current is in each case transmitted via feedback 23 to an analog-digital converter 24, which converts the analog direct current into a digital signal and transmits it to the CPU 17. The CPU 17 can then performs linearization of the output signal 20 when driving the power unit 19. In this way, a particularly uniform output signal 20 can be achieved.

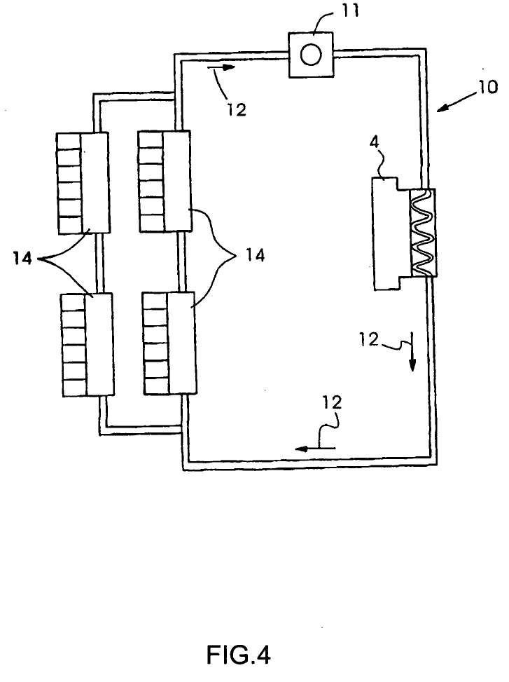

FIG. 4 shows a specific embodiment of the temperature control apparatus for the laser module 4. Here, identical designations also again designate the same elements as in the preceding drawings.

The cooling liquid circuit 10 is split here, so that a plurality of Peltier elements 14 can be connected in parallel and in series and are thus able to cool the cooling liquid circuit 10 accordingly. Heating of the cooling liquid can be provided in exactly the same way. In this case, the different Peltier elements 14 are driven as in the preceding drawings, in particular by a drive as has been described in more detail in FIG. 2. In the case illustrated here, in each case two Peltier elements 14 are connected in series and these are in turn connected in parallel with a further pair of Peltier elements 14 connected in series. In this way, first advantageous redundancy of the Peltier elements can be achieved and, additionally, a higher cooling or heat output of the Peltier elements 14 is also achieved. Each Peltier element 14 can have its own heat sink 15 with a corresponding fan 16. In this way, the serviceability of the temperature control apparatus can be increased accordingly.

The accommodation in this way of a temperature control apparatus having the Peltier element 14 or, as here, having a plurality of Peltier elements 14 connected in series and in parallel, directly in the region of the laser module 4 is generally not possible because of the configuration. The laser module 4 cannot have its temperature controlled directly by a plurality of Peltier elements 14. This is made possible only by the use of the cooling circuit 10 for the transport of the heat from and to the Peltier elements 14.

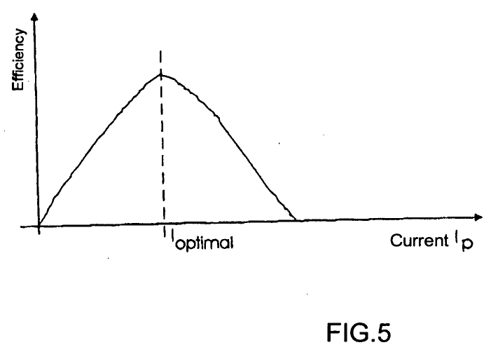

The efficiency of the Peltier element 14 depends on the current I_{P} which is used for the drive. The efficiency itself has a maximum at an optimum current Iₒₚₜᵢₘᵤₘ. If the intensity of the current I_{P} goes beyond this value, then the efficiency of the Peltier element decreases again. In this case, the efficiency is understood to be the ratio of the heat flow to the electric power supplied. A typical course of the efficiency as a function of the current I_{P} is illustrated in FIG. 5. By using a plurality of Peltier elements 14 for controlling the temperature of the cooling liquid of the cooling liquid circuit 10, it is ideally possible for each Peltier element 14 to be operated in the region of the optimal efficiency. This makes particularly efficient cooling possible. Of course, particularly efficient heating as well.

Here, of course it is in particular also possible to provide for not all the Peltier elements 14 to be used, depending on the necessary heat output of the temperature control apparatus, but in each case for different ones to be driven. These can then be operated in the region of the optimal efficiency.

By the temperature control apparatuses described here, it is possible to achieve a constant temperature of the laser modules 4. By the cooling liquid in the cooling liquid circuit 10, the heat is transported away from the laser modules 4 and transferred to the Peltier elements 14. Heating is likewise possible. A constant temperature can then be maintained. The Peltier elements 14 can be located in a region of the printing plate exposer where sufficient space and appropriate convection by fans can be made possible. The Peltier elements 14 cannot be operated directly on the laser modules 4 in particular in an external drum exposer. It is then sufficient to circulate the cooling liquid of the cooling liquid circuit 10 by the low-pressure pump 11. As a result, few faults are to be expected. The cooling liquid itself does not have to be cooled by a compressor either. A compressor would at least impair an imaging result on the printing plate 1 through its oscillations. Furthermore, by the simultaneous use of a plurality of Peltier elements 14 in series and/or parallel with one another, a cooling output for the laser modules 4 can be achieved which would otherwise be achievable only via a compressor-cooled liquid circuit 10. By this measure, a better printing image can be achieved, since vibrations are avoided. More efficient cooling is also possible. The Peltier elements 14 can be located directly in the region of the outer walls of the printing plate exposer. In this way, the waste heat can be led directly to the outside from the printing plate exposer by the fans 16.

This application claims the priority, under 35 U.S.C. §119, of German application DE 10 2005 036 099.8, filed Aug. 1, 2005; the prior application is herewith incorporated by reference in its entirety.

We claim:

1. A method for controlling a temperature of a laser module having at least one laser diode driven in a modulated manner for imaging a printing form in an exposer, and a Peltier element, which comprises the steps of:
cooling the laser module by leading heat from the laser module to the Peltier element through a heat conduit.

2. The method according to claim 1, which further comprises cooling and heating the laser module by leading the heat from and/or to the laser module through the heat conduit to and/or from the Peltier element.

3. The method according to claim 1, which further comprises disposing the Peltier element at a distance from the laser module in a region of the exposer which offers sufficient space for the Peltier element.

4. The method according to claim 3, which further comprises:
providing the Peltier element with a heat sink for exchanging of heat with the surroundings; and
actively cooling the heat sink with a fan.

5. The method according to claim 1, which further comprises driving the Peltier element in an analog manner by using a bipolar power unit driven digitally in a clocked manner in accordance with a principle of pulse width modulation.

6. The method according to claim 5, which further comprises driving the Peltier element in a regulated manner in dependence on temperature changes of the laser module.

7. The method according to claim 1, which further comprises driving the Peltier element actively in dependence on modulation of laser diodes of the laser module.

8. The method according to claim 1, which further comprises using a cooling liquid circuit as the heat conduit for performing thermal conduction.

9. The method according to claim 8, which further comprises operating at least two Peltier elements for applying or discharging the heat to or from the cooling liquid circuit in parallel or in series.

10. The method according to claim 8, which further comprises operating at least three Peltier elements for applying or discharging the heat to or from the cooling liquid circuit in parallel and in series.

11. The method according to claim 8, which further comprises providing a low-pressure pump for circulating a cooling liquid in the cooling liquid circuit.

12. An apparatus for controlling a temperature of a laser module having at least one laser diode driven in a modulated manner for imaging a printing form in an exposer, the apparatus comprising:
a heat transport device; and
at least one Peltier element disposed in a region of the exposer, separated physically from the laser module, and thermally coupled to the laser module through said heat transport device for thermal conduction for cooling and/or heating the laser module.

13. The apparatus according to claim 12, further comprising:
a digital drive device; and
a bipolar power unit being driven digitally in a clocked manner by said digital drive device and outputting analog output signals for driving said Peltier element in an analog manner.

14. The apparatus according to claim 12, further comprising a feedforward control unit for regulating a driving of said Peltier element in dependence on modulation signals of the laser module.

15. The apparatus according to claim 13, further comprising at least one analog/digital converter for feeding the analog output signals of said bipolar power unit back to said digital drive device for linearizing the analog output signals.

16. The apparatus according to claim 12, wherein said heat transport device is a cooling liquid circuit.

17. The apparatus according to claim 16, further comprising a low-pressure pump for circulating a liquid of said cooling liquid circuit.

18. The apparatus according to claim 17, wherein said low-pressure pump has a pump with a spherically shaped, magnetically mounted rotor or impeller.

19. The apparatus according to claim 16, wherein said Peltier element is one of at least two Peltier elements connected in parallel or in series for applying and/or discharging heat to and/or from said cooling liquid circuit.

20. The apparatus according to claim 16, wherein said Peltier element is one of at least three Peltier elements connected in parallel and in series for applying and/or discharging heat to and/or from said cooling liquid circuit.
